(19) United States
(12) Patent Application Publication
(10) Pub. No.: US 2009/0190161 A1
(43) Pub. Date: Jul. 30, 2009

(54) Printing apparatus and method of controlling the same

(75) Inventor: Ji-hyun Goh, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co.,Ltd., Changwon-city (KR)

(21) Appl. No.: 12/316,617

(22) Filed: Dec. 15, 2008

(30) Foreign Application Priority Data
Jan. 28, 2008 (KR) 10-2008-0008711

(51) Int. Cl. G06F 3/12; G05B 19/00

(52) U.S. Cl. 358/1.15; 340/5.8

(57) ABSTRACT

A printing apparatus is provided for obtaining pickup information of users and determining a print order in accordance with the pickup information in consideration of different pickup patterns of the users for picking up printed documents, and a method of controlling the printing apparatus, in order to minimize time and effort of users.

### CROSS-REFERENCE TO RELATED PATENT APPLICATION

This application claims the benefit of Korean Patent Application No. 10-2008-0008711, filed on Jan. 28, 2008, in the Korean Intellectual Property Office, the disclosure of which is incorporated herein in its entirety by reference.

### BACKGROUND

The present invention relates to a printing apparatus and a method of controlling the same, and more particularly, to a printing apparatus shared by a plurality of users and a method of controlling the same.

If a printing apparatus is shared by a plurality of users, the users may have different pickup patterns for picking up printed documents. For example, a user may want to pick up a printed document soon and another user may want to pick up a printed document later.

Conventionally, the printing apparatus determines an order of print request signals of the users as a print order so as to print data. In this case, the user who wants to pick up the printed document soon may feel inconvenienced if the desired data is not promptly printed and is delayed on a print waiting list due to previous data to be printed, and thus the user has to wait around near the printing apparatus for a long period of time. Furthermore, the printed document of the other user who wants to pick up the printed document later may not be picked up for a long period of time after the printed document is completely generated, and thus the printed document is placed in a pile.

### SUMMARY

The present invention provides a printing apparatus by which waiting time of users may be minimized and efforts for picking up printed documents may not be wasted by determining a print order of data in accordance with characteristics of the users in consideration of a fact that the users may have different pickup patterns for picking up the printed documents, and a method of controlling the printing apparatus.

According to an aspect of the present invention, there is provided a method of controlling a printing apparatus, the method including receiving a print request signal and data to be printed from a first user; detecting pickup information of the first user; determining a print order in accordance with the pickup information; and generating a printed document by printing the data in accordance with the print order.

The pickup information may include a first period from a reception time of the print request signal until a pick up time of the printed document, or a second period from a print completion time until the pick up time of the printed document.

The print order may be determined so that the smaller the first or second period of a user is, the sooner data of the user is printed.

The method may further include sensing and storing the reception time of the print request signal of the first user. The method may further include sensing and storing the print completion time. The method may further include recognizing that the first user is approaching the printer; and sensing and storing a time when the first user approaches.

The first user may have a radio-frequency identification (RFID) tag and the printing apparatus may include an RFID reader so that the printing apparatus recognizes that the first user is approaching the printer.

The method may further include calculating a first period from a reception time of the print request signal until a pick up time of the printed document, or a second period from a print completion time until the pick up time of the printed document.

The method may further include updating the pickup information by using a most currently calculated first or second period. The pickup information may be calculated by averaging at least one previously calculated first period and a currently calculated first period or averaging at least one previously calculated second period and a currently calculated second period. A larger weight may be applied to a more currently calculated first or second period.

The method may further include receiving the print request signal and the data to be printed from a second user. The print request signal of the second user may include a priority print request signal. The print order may be determined so that the data of the second user is printed sooner than the data of the first user, regardless of the pickup information of the second user. The print order may be determined by changing the pickup information of the second user. The method may further include recognizing that the second user is approaching the printer.

The print order may be determined so that the data of the second user is printed sooner than the data of the first user, by recognizing that the second user is approaching the printer.

The print order may be determined by changing the pickup information of the second user in order to print the data of the second user more quickly than data of the other user, by recognizing that the second user is approaching the printer. For example, when the pickup information means a period that it takes for the second user to pick up a printed document corresponding to the data of the second user, the print order may be determined by reducing the period of the second user by recognizing that the second user is approaching the printer.

If the print order of data has already changed a predetermined number of times or more than the predetermined number of times, the print order of the data may be determined regardless of the pickup information so that the data is printed with priority. When the print order of the data is determined regardless of the pickup information so that the data is printed with priority, the print order of the data may be fixed so as not to be changed or priority may be given to the data.

According to another aspect of the present invention, there is provided a printing apparatus including a communication unit for receiving a print request signal and data to be printed from a user; a print order determination unit for determining a print order in accordance with pickup information of the user; and a printing unit for generating a printed document by printing the data in accordance with the print order.

The print order determination unit may include a storage determination unit for determining whether the pickup information of the user exists. The print order determination unit may include a detection unit for detecting the pickup information of the user if the storage determination unit determines that the pickup information of the user exists.

The print order determination unit may include a waiting data determination unit for determining whether print waiting data exists. The print order determination unit may include a comparison and determination unit for comparing and determining the pickup information of the user and the pickup information corresponding to the print waiting data.

The pickup information may include a first period from a reception time of the print request signal until a pick up time of the printed document, or a second period from a print completion time until the pick up time of the printed document.

The comparison and determination unit may compare and determine the first or second period. The print order determination unit may include a control unit for determining the print order so that the smaller the first or second period of a user is, the sooner data of the user is printed, in accordance with a determination result of the comparison and determination unit.

The printing apparatus may further include a pickup information update unit for updating the pickup information by using a most currently calculated first or second period. The printing apparatus may further include a user recognition unit for recognizing that the user is approaching the printer.

The print order determination unit may include a priority determination unit for determining that the data of the user is priority data if the user recognition unit recognizes that the user is approaching the printer.

The print order determination unit may include a priority determination unit for determining that the data of the user is priority data by a priority print request signal if the print request signal includes the priority print request signal.

The print order determination unit may include a number determination units for determining whether the print order is changed a predetermined number of times or more than the predetermined number of times.

If the print order of data has already changed a predetermined number of times or more than the predetermined number of times, the control unit may determine the print order by fixing the print order of the data so as not to be changed or giving priority to the data.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for describing a network of a printing apparatus according to an embodiment of the present invention;

FIG. 2 is a block diagram of a printing apparatus according to an embodiment of the present invention;

FIG. 3 is a block diagram of a print order determination unit illustrated in FIG. 2, according to an embodiment of the present invention;

FIG. 4 is a block diagram of a pickup information update unit illustrated in FIG. 2, according to an embodiment of the present invention;

FIG. 5 is a flowchart of a method of controlling a printing apparatus, according to an embodiment of the present invention;

FIGS. 6A and 6B are tables for describing a method of determining a print order, according to an embodiment of the present invention;

FIG. 7 is a flowchart of a method of updating pickup information, according to an embodiment of the present invention;

FIG. 8 is a flowchart of a method of updating pickup information, according to another embodiment of the present invention;

FIGS. 9A and 9B are tables showing pickup information updated by using the method of FIG. 8, according to an embodiment of the present invention;

FIG. 10 is a flowchart of a method of printing data with priority, according to an embodiment of the present invention;

FIG. 11 is a diagram of an exemplary display screen for generating a priority print request signal, according to an embodiment of the present invention;

FIG. 12 is a flowchart of a method of printing data with priority, according to another embodiment of the present invention; and

FIG. 13 is a flowchart of a method of determining a print order by restricting the number of print order changes, according to an embodiment of the present invention.

### DETAILED DESCRIPTION OF THE PREFERRED EMBODIMENTS

Hereinafter, the present invention will be described in detail by explaining embodiments of the invention with reference to the attached drawings. In the following description of various embodiments of the present invention, a detailed description of known functions and configurations incorporated herein will be omitted when such functions and configurations are well-known by one of ordinary skill in the art.

Also, terms or words used in the following description and claims should be interpreted as broadly as permitted and as one of ordinary skill would construe them.

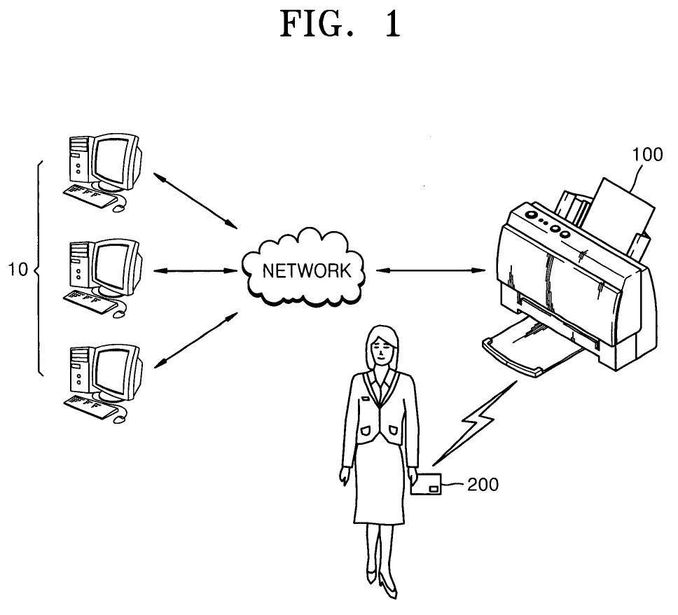

FIG. 1 is a diagram for describing a network of a printing apparatus shared by a plurality of users, according to an embodiment of the present invention.

Referring to FIG. 1, the users transmit data to be printed and print request signals to a printer by using, e.g., personal computers (PCs) 10. The printer 100 prints the date input from the PCs 10. In this case, when the users separately transmit the print request signals, the printer 100 determines a print order in accordance with pickup information of the users so as to print the data. A method of determining the print order will be described in detail below.

Also, a user 200 has a radio-frequency identification (RFID) tag and the printer includes an RFID reader. Thus, if the user 200 approaches the printer 100, the printer 100 may recognize the user 200 by receiving tag information from the user 200 through the RFID reader.

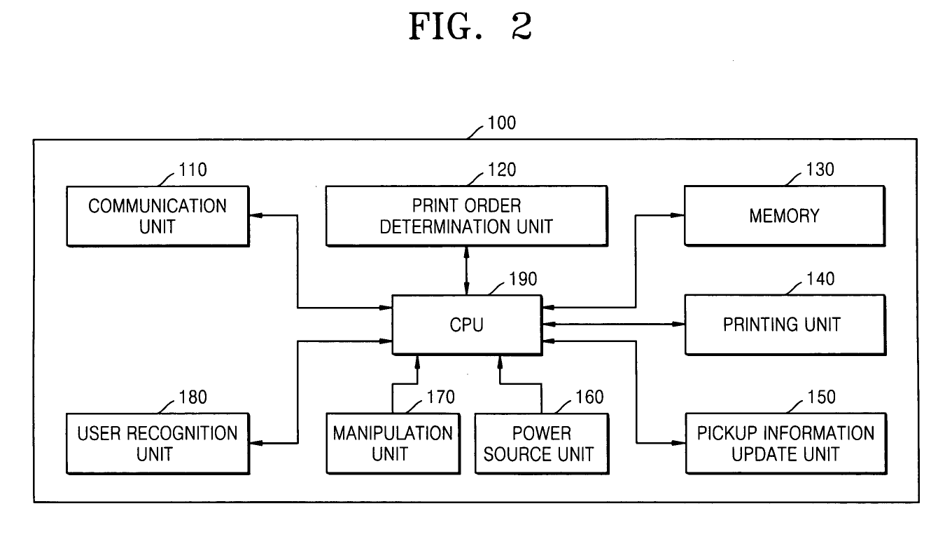

FIG. 2 is a block diagram of a printing apparatus 100 according to an embodiment of the present invention.

Referring to FIG. 2, the printing apparatus 100 includes a communication unit 110, a print order determination unit 120, a memory 130, a printing unit 140, a pickup information update unit 150, a power source unit 160, a manipulation unit 170, a user recognition unit 180, and a central processing unit (CPU) 190.

The communication unit 110 receives data to be printed and print request signals from, for example, PCs of users. The communication unit 110 may be connected to the PCs of the users through wires such as cables, or wirelessly.

The print order determination unit 120 determines a print order of the data. The print order determination unit 120 determines the print order by using pickup information of the users. Here, each piece of the pickup information includes a first period from a reception time of a print request signal until a pick up time of a printed document, or a second period from a print completion time until the pick up time of the printed document.

Accordingly, the print order may be determined so that data of a user who wants to pick up a printed document soon is printed with priority. That is, the print order may be determined so that the smaller the first or second period of a user is, the sooner data of the user is printed. In particular, the first period includes a period for printing data, and thus time delay may occur for the first period in accordance with the capacity of the data to be printed. However, unless a user wants to print a large amount of data, e.g., data of hundreds of pages or more, the time delay does not significantly influence the pickup information. Thus, the first period may also be considered as the pickup information.

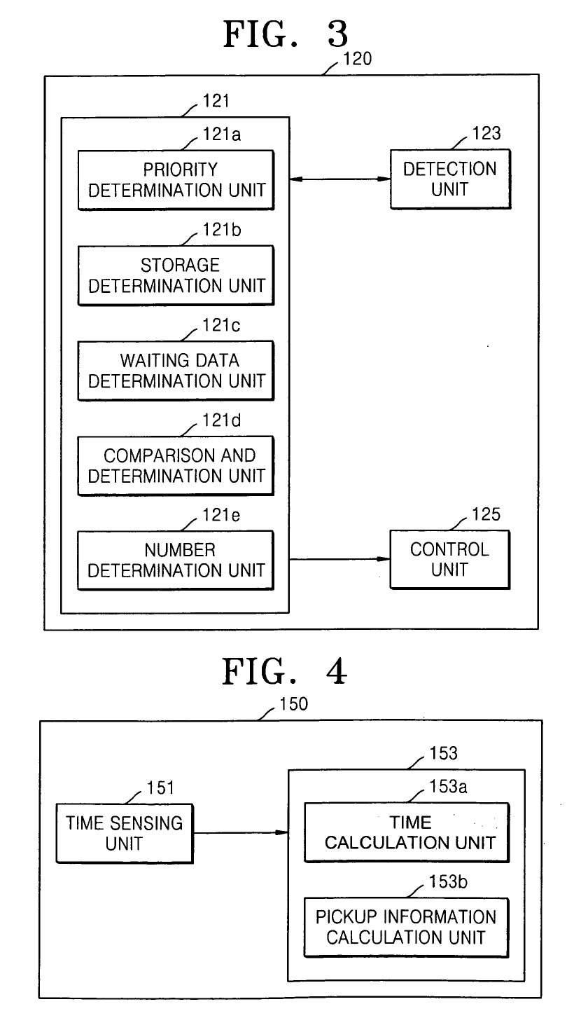

The print order determination unit 120 will be described in detail later with reference to FIG. 3.

The memory 130 stores an operating system and an application program for operating the printing apparatus 100. Also, the memory 130 temporarily stores data for the operating system and the application program, or the data to be printed. Furthermore, the memory 130 may store a database of the pickup information of the users. The database may be located outside the printing apparatus 100 such that the printing apparatus 100 may access the database through the communication unit 110.

The printing unit 140 prints the data in accordance with the print order determined by the print order determination unit 120.

The printing apparatus 100 may include the pickup information update unit 150 and the pickup information update unit 150 may obtain the pickup information of the users by sensing and calculating current pickup information and the pickup information may be updated into the current pickup information to be used later again. The pickup information may be obtained by averaging previous pickup information. In particular, a larger weight may be applied to more current pickup information.

The printing apparatus 100 may include the power source unit 160 for supplying power so that the print order is determined and that the data is printed in accordance with the print order. The power source unit 160 may include a connection member for receiving power from an external power source device.

Also, the printing apparatus 100 may include the manipulation unit 170 to be manipulated by the users to turn on the printing apparatus 100 or to transmit the print request signals. The manipulation unit 170 may have various forms such as a manipulation button, a remote controller, and a touch screen.

The printing apparatus 100 may include the user recognition unit 180. The user recognition unit 180 may recognize a user if the user approaches the printing apparatus 100 within a predetermined range. For example, if the user has an RFID tag, the user recognition unit 180 may be an RFID reader. Thus, the user recognition unit 180 may recognize that the user approaches by using wireless RFID communication. If the user approaches, the user recognition unit 180 may determine that the user wants to pick up the printed document.

The printing apparatus 100 includes the CPU 190 for controlling general operations for determining the print order and printing the data.

FIG. 3 is a block diagram of the print order determination unit 120 illustrated in FIG. 2, according to an embodiment of the present invention.

Referring to FIG. 3, the print order determination unit 120 includes a determination unit 121, a detection unit 123, and a control unit 125.

The determination unit 121 includes a priority determination unit 121a for determining whether priority is given to data to be printed. If a priority print request signal is included in a print request signal of the data, the priority determination unit 121a may determine that priority is given to the data by the priority print request signal. Alternatively, if the user recognition unit 180 illustrated in FIG. 2 recognizes that a user approaches, the priority determination unit 121a may determine that priority is given to data requested by the user. If the priority determination unit 121a determines that priority is given to the data, the control unit 125 may determine a print order so that the data is printed with priority.

The determination unit 121 may include a storage determination unit 121b for determining whether pickup information is stored. If the print request signal is received from a user, the storage determination unit 121b may determine whether the pickup information of the user exists. The pickup information of the user may be stored in the memory 130 illustrated in FIG. 2 or an external device connected to the printing apparatus 100 illustrated in FIG. 2. If the storage determination unit 121b determines that the pickup information of the user exists, the detection unit 123 may detect the pickup information of the user.

The determination unit 121 may include a waiting data determination unit 121c for determining whether data requested to be printed by another user exists on a print waiting list.

The determination unit 121 includes a comparison and determination unit 121d for comparing and determining the pickup information of users. The comparison and determination unit 121d compares the pickup information of a first user who has currently requested to print data, to the pickup information of a second user who has previously requested to print data. Each piece of the pickup information represents a period of time. The comparison and determination unit 121d determines which one is larger or smaller than the other between the pickup information of the first user and the pickup information of the second user. The pickup information determined by the comparison and determination unit 121d is detected by the detection unit 123. Thus, the comparison and determination unit 121d may compare the pickup information provided by the detection unit 123.

Then, the control unit 125 may determine the print order in accordance with the pickup information determined by the comparison and determination unit 121d. That is, if the comparison and determination unit 121d determines that the pickup information of the first user is smaller than or equal to the pickup information of the second user, the control unit 125 may determine the print order so that data of the first user is printed sooner than the data of the second user. If the comparison and determination unit 121d determines that the pickup information of the first user is larger than the pickup information of the second user, the control unit 125 may determine the print order so that the data of the second user is printed sooner than the data of the first user.

Also, the determination unit 121 may include a number determination unit 121e for determining the number of print order changes indicating how many times the print order is changed. If the number determination unit 121e determines that the print order of data of a certain user is changed a predetermined number of times or more than the predetermined number of times, the control unit 125 may determine the print order so that the data is printed with priority or the print order of the data is not changed any more.

FIG. 4 is a block diagram of the pickup information update unit 150 illustrated in FIG. 2, according to an embodiment of the present invention. Referring to FIG. 4, the pickup information update unit 150 includes a time sensing unit 151 and a calculation unit 153.

A first period from a reception time of a print request signal until a pick up time of a printed document, or a second period from a print completion time until the pick up time of the printed document, may be used as pickup information. Thus, the time sensing unit 151 may sense the reception time of the print request signal and the pick up time of the printed document. Alternatively, the time sensing unit 151 may sense the print completion time and the pick up time of the printed document. The pick up time of the printed document may be a time when the user recognition unit 180 illustrated in FIG. 2 recognizes that a user approaches, or a time when a printed document is picked up from a releaser for releasing the printed document from the printing apparatus 100.

As such, the first or second period is calculated based on the sensed times. The first or second period may be calculated by the period calculation unit 153a. The first or second period which is previously calculated when the user has requested to print data before may be used as the pickup information. Preferably, an average of previously calculated first periods or the average of previously calculated second periods may be used as the pickup information. More preferably, the average may be obtained by applying a larger weight to a more current period. The obtaining of the averages and the applying of the weight may be performed by the pickup information calculation unit 153b.

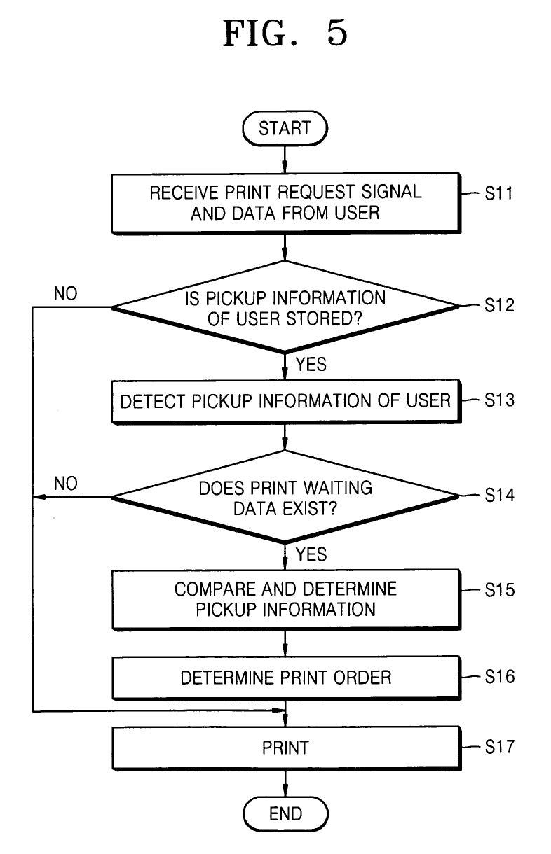

A method of controlling a printing apparatus, according to embodiments of the present invention, will now be described. FIG. 5 is a flowchart of a method of controlling a printing apparatus, according to an embodiment of the present invention. Referring to FIG. 5, initially, a print request signal and data to be printed are received from a user in operation S11. Then, it is determined whether pickup information of the user is stored, in operation S12. If the pickup information of the user is stored, the pickup information is detected in operation S13.

It is determined whether data requested to be printed by another user exists on a print waiting list in operation S14. That is, it is determined whether print waiting data exists. If the print waiting data exists, the pickup information of the user and the pickup information of the other user corresponding to the print waiting data are compared and determined in S15.

Then, a print order is determined in accordance with the pickup information in operation S16. The print order is determined so that data having small pickup information is printed with priority.

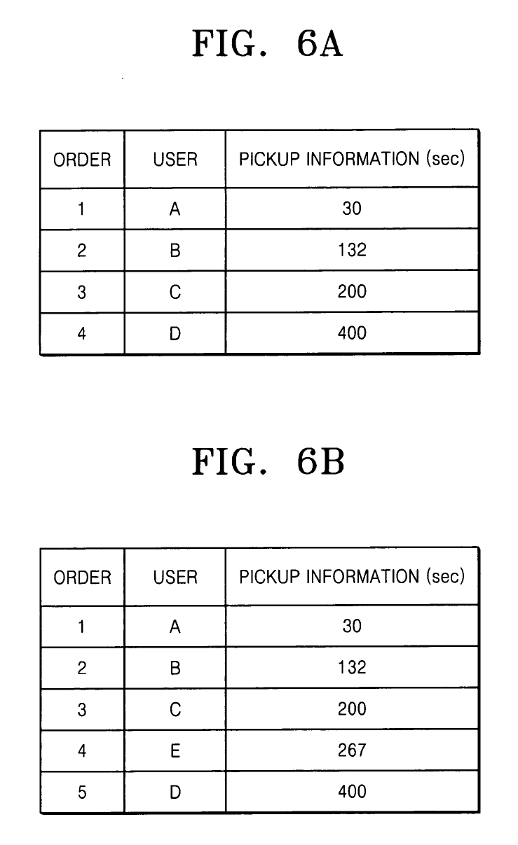

FIGS. 6A and 6B are tables for describing a method of determining a print order, according to an embodiment of the present invention.

In FIG. 6A, a printing apparatus has a print waiting list of data of users A, B, C, and D in a described order. In this case, if user E requests to print data, pickup information of user E and the pickup information of users A, B, C, and D are compared and determined. The pickup information of user E is 267 sec. and thus is disposed between 200 sec. that is the pickup information of user C and 400 sec. that is the pickup information of user D. Accordingly, the print order of the data of user E is posterior to the data of user C and prior to the data of user D as shown in FIG. 6B. Thus, due to a new user, the print order is changed into an order of the data of users A, B, C, E, and D.

Referring back to FIG. 5, the data is printed in accordance with the print order in operation S17. If the pickup information of the user is not stored, the received data is printed in operation S17. Also, if the print waiting data does not exist, the received data is printed in operation S17.

FIG. 7 is a flowchart of a method of updating pickup information, according to an embodiment of the present invention. Referring to FIG. 7, a reception time of a print request signal of a user is sensed and stored, in operation S21. Then, a printing apparatus prints data by using the method illustrated in FIG. 5. Then, it is recognized that the user is approaching the printer, in operation S22. A time when the user approaches is sensed and stored, in operation S23.

A first period is calculated by obtaining a difference between the reception time of the print request signal and the time when the user approaches, in operation S24. The pickup information is updated by using the first period, in operation S25.

If the user requests to print data later again, the calculated first period may be used as the pickup information of the user in order to compare the pickup information of the user to the pickup information of another user. That is, the pickup information may be updated by using the calculated first period.

In addition to the first period that is calculated by using the print request signal in operation S21, an average of one or more previous first periods which are calculated by using previous print request signals of the user may also be used as the pickup information of the user when the user requests to print data later again. That is, the pickup information may be updated by using the average of the plurality of the previous first periods.

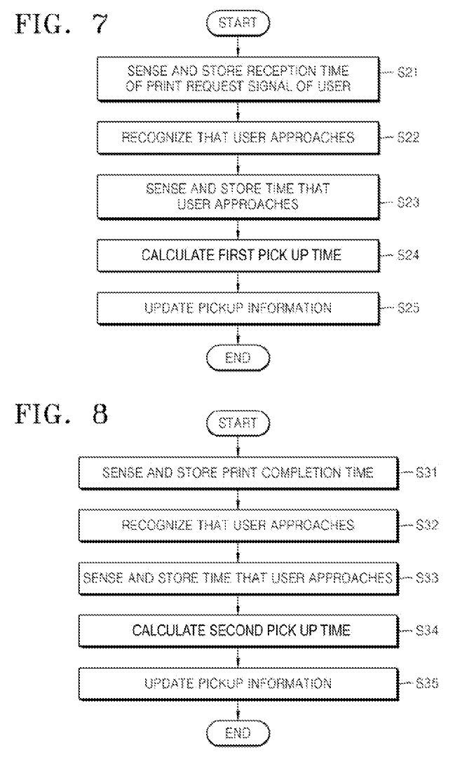

FIG. 8 is a flowchart of a method of updating pickup information, according to another embodiment of the present invention. According to this embodiment of the present invention, the pickup information is updated by using a second period from a print completion time until a pick up time of a printed document.

Referring to FIG. 8, a print request signal and data are received from a user, the data is printed by using the method illustrated in FIG. 5, and a print completion time is sensed and stored, in operation S31. The print completion time may be a time when the printer completely finishes printing the data and generating a printed document corresponding to the data. Then, it is recognized that the user approaches, in operation S32. A time when the user approaches is sensed and stored, in operation S33. The second period is calculated by obtaining a difference between the print completion time and the time when the user approaches, in operation S34. The pickup information is updated by using the second period, in operation S35.

As described above with reference to FIG. 7, if the user requests to print data later again, the calculated second period may be used as the pickup information of the user.

However, preferably, the pickup information may be updated by using one or more previous second periods that are calculated when the user has requested to print data before.

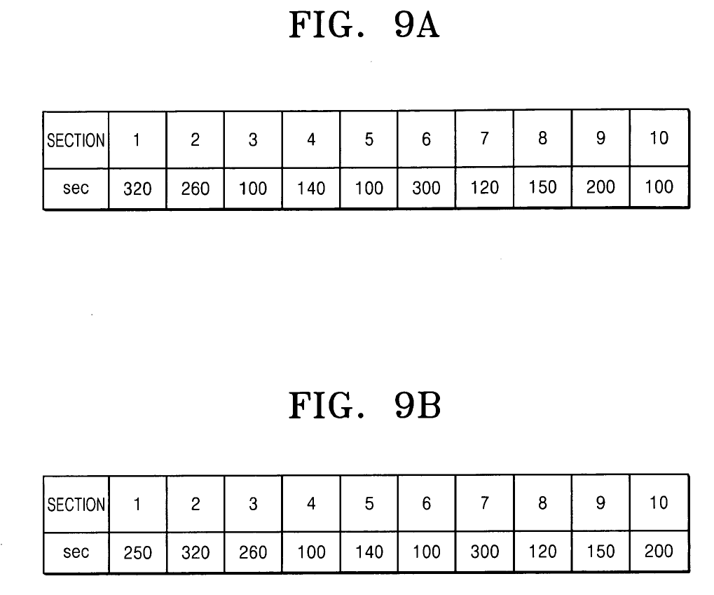

FIGS. 9A and 9B are tables showing pickup information updated by using the method of FIG. 8, according to an embodiment of the present invention. Referring to FIGS. 9A and 9B, a memory is divided into ten sections and a previously calculated second period is stored in each section.

A current second period calculated after a print request signal of a user is received and then data is printed by the print request signal, is 250 sec. Thus, 250 sec. is newly stored in section 1 of the memory. Then, an average of second periods of sections 1 through 10 is newly calculated. In this case, the most current second period is stored in section 1, a less current second period is stored in a larger number of section, and the least current second period is stored in section 10. Thus, the average may be calculated by applying a larger weight to a more current second period. For example, the average may be calculated by applying a weight five to sections 1 and 2, a weight four to sections 3 and 4, a weight three to sections 5 and 6, a weight two to sections 7 and 8, and a weight one to sections 9 and 10. In this case, the average of the second periods is 267.3333 sec.

Accordingly, the pickup information is updated to be 267 sec. and 267 sec. may be used as the pickup information when the user requests to print data later again.

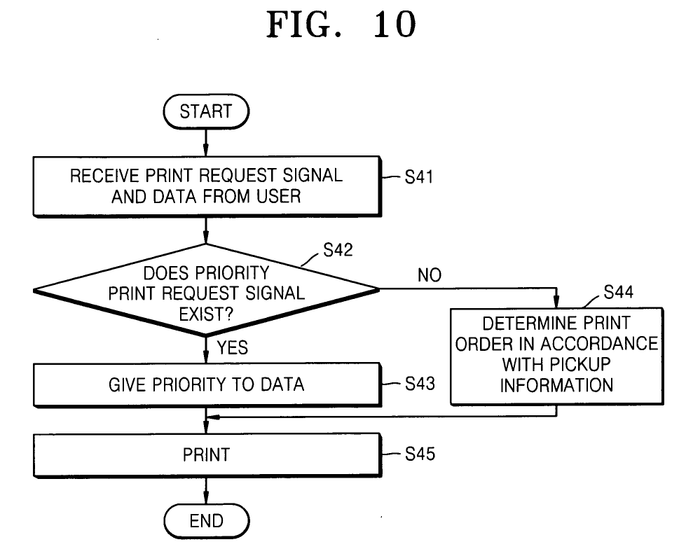

A method of printing data with priority, according to embodiments of the present invention, will now be described with reference to FIGS. 10 through 12.

FIG. 10 is a flowchart of a method of printing data with priority, according to an embodiment of the present invention. Referring to FIG. 10, initially, a print request signal and data to be printed are received from a user in operation S41. It is determined whether the print request signal is a priority print request signal in operation S42. For example, the priority print request signal may be generated by selecting a priority menu when the user requests to print the data.

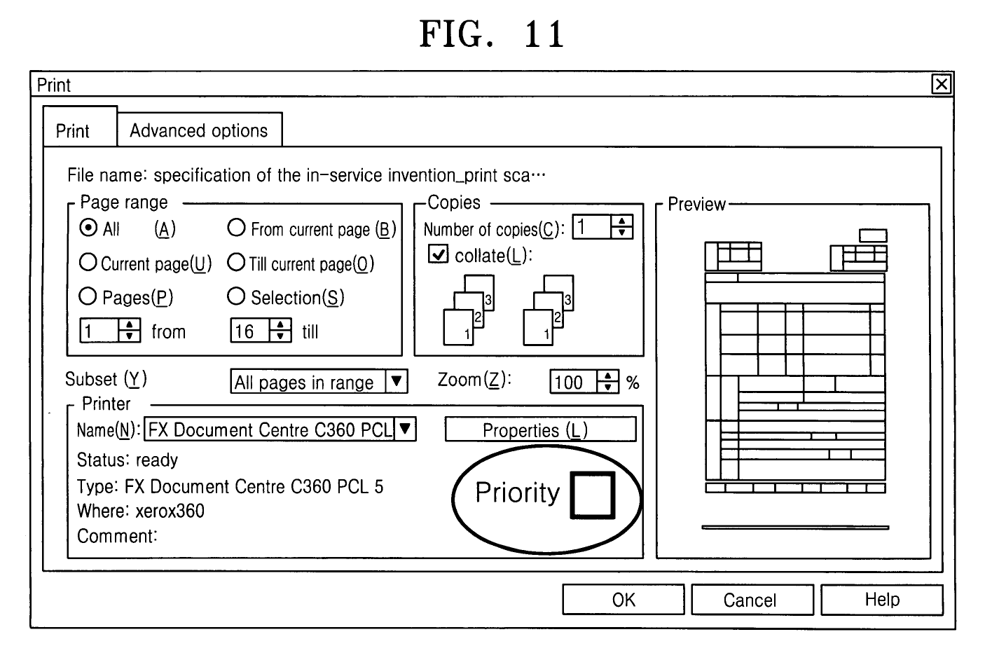

FIG. 11 is a diagram of an exemplary screen for generating a priority print request signal, according to an embodiment of the present invention. Referring to FIG. 11, a priority box is included in a print request window and the priority print request signal may be generated by putting a check mark in the priority box.

Referring back to FIG. 10, if the print request signal is the priority print request signal, a print order is determined so that the received data is printed with priority in operation S43. If the print request signal is not the priority print request signal, the print order is determined in accordance with pickup information of the user by using the method illustrated in FIG. 5, in operation S44.

The data is printed in accordance with the determined print order in operation S45. If the data is printed in a priority mode as described above, a calculated first or second period may not be used to update the pickup information.

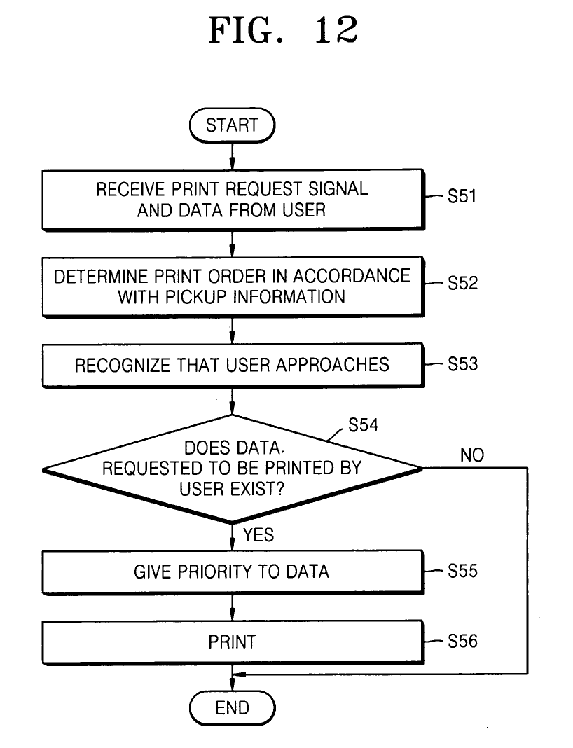

FIG. 12 is a flowchart of a method of printing data with priority, according to another embodiment of the present invention. Referring to FIG. 12, initially, a print request signal and data to be printed are received from a user in operation S51. A print order is determined in accordance with pickup information of the user in operation S52. Then, if it is recognized that the user approaches in operation S53, it is determined whether the data requested by the user exists on a print waiting list in operation S54.

If the requested data exists on the print waiting list, priority is given to the data of the user in operation S55. If the user approaches, it may be determined that the user wants to pick up a printed document. By giving priority to the data of the user, a waiting time of the user may be minimized. When priority is given to the data, a top priority may be given or a certain priority may be given by changing the pickup information of the user in order to print the data of the user faster than data of the other user. For example, when the time that it takes for the user to pick up the printed document is used as the pickup information, regarding changing the pickup information of the user, it means to reduce the pick up time of the user. Particularity, the period may be reduced by one twice. When the period of the user is 200 seconds generally, the period of the user with the priority may be reduced to 100 seconds. Accordingly, the user with the priority may have a high printing order. The data is printed in accordance with the print order that is determined by giving priority to the data, in operation S56. If the requested data does not exist on the print waiting list in operation S54, the data is already printed such that the method may be terminated.

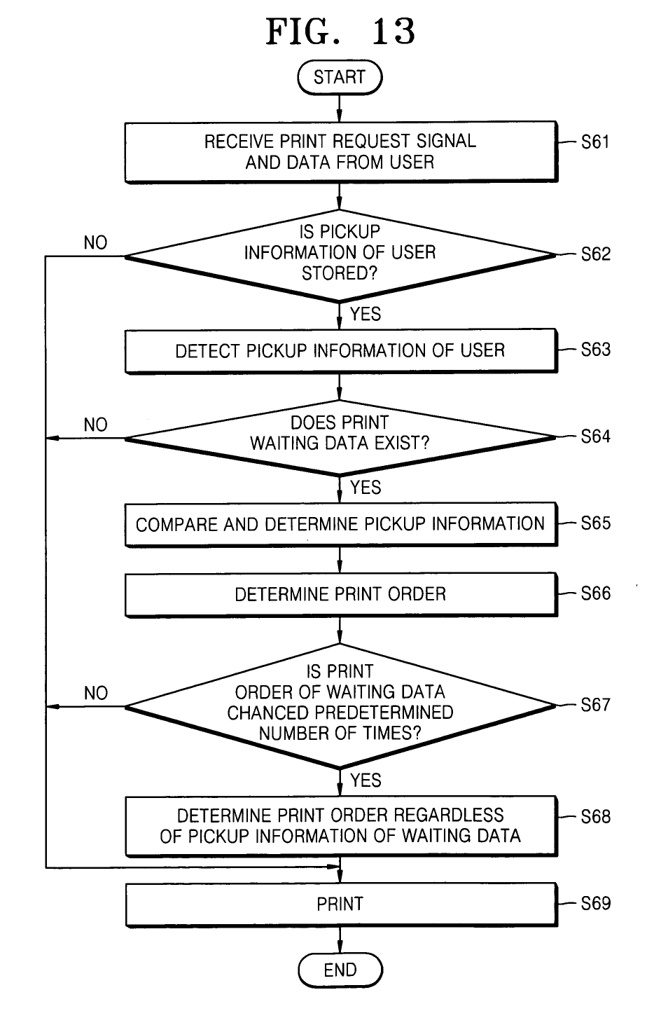

FIG. 13 is a flowchart of a method of determining a print order by restricting the number of print order changes, according to an embodiment of the present invention. When the print order is determined by using pickup information of a user, although the user has requested to print data soon, if the print order of the data is continuously changed, an unlimited printing delay may occur to the data. The restricting of the number of print order changes is necessary in order to prevent such a case.

Referring to FIG. 13, a print request signal and data to be printed are received from a user in operation S61. Then, it is determined whether pickup information of the user is stored, in operation S62. If the pickup information of the user is stored, the pickup information is detected in operation S63. Then, it is determined whether previously requested data to be printed exists on a print waiting list. That is, it is determined whether print waiting data exists, in operation S64.

If the print waiting data exists, the pickup information of the user and the pickup information corresponding to the print waiting data are compared and determined in S65. Then, a print order is determined in accordance with the pickup information in operation S66.

In this case, it is determined whether the print order is changed a predetermined number of times or more than the predetermined number of times, in operation S67.

For example, in FIGS. 6A and 6B, a print waiting list is made so that data of users A, B, C, and D is printed in a described order. In this case, if user E requests to print data, a print order is determined by comparing and determining pickup information of user E and the pickup information of users A, B, C, and D. Accordingly, the print order may be changed into an order of the data of users A, B, C, E, and D. Here, the print order of the data of user D is changed from a fourth to a fifth due to user E. In this case, it is determined whether the print order of the data of user D is changed a predetermined number of times or more than the predetermined number of times. If it is assumed that the print order of the data of user D has been previously changed twice, in total, the print order of the data of user D is changed three times. If it is assumed that the predetermined number of times is three times, the print order of the data of user D is changed the predetermined number of times.

If the print order of the print waiting data is changed the predetermined number of times or more than the predetermined number of times, the print order may be determined regardless of the pickup information of the print waiting data, in operation S68.

For example, in FIGS. 6A and 6B, the print order may be determined by comparing and determining the pickup information of users A, B, C, and E, except for user D. Alternatively, the print order may be determined by comparing and determining the pickup information of users A, B, C, D, and E, and then the print order of the data of user D may be re-determined so that the data of user D is printed with priority. That is, an unlimited printing delay may be prevented by restricting the number of print order changes on the data of which the print order is changed the predetermined number of times or more than the predetermined number of times. The data is printed in accordance with the print order that is determined as described above, in operation S69.

If the pickup information of the user is not stored, the data of the user may be printed without determining the print order in accordance with the pickup information, in operation S69.

As described above, according to the present invention, a printing apparatus may print data by automatically determining a print order in accordance with different pickup patterns of users for picking up printed documents and thus time and efforts of the users may be minimized.

The system or systems may be implemented on any general purpose computer or computers and the components may be implemented as dedicated applications or in client-server architectures, including a web-based architecture. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions executable on the processor on media such as tape, CD-ROM, etc., where this media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method of controlling a printing apparatus, the method comprising:
receiving a print request signal and data to be printed from a first user;
detecting pickup information of the first user;
determining a print order in accordance with the pickup information; and
generating a printed document by printing the data in accordance with the print order.

2. The method of claim 1, wherein the pickup information comprises a first period from a reception time of the print request signal until a pick up time of the printed document, or a second period from a print completion time until the pick up time of the printed document.

3. The method of claim 2, wherein the print order is determined so that the smaller the first or second period of a user is, the sooner data of the user is printed.

4. The method of claim 1, further comprising:
recognizing that the first user is approaching the printer; and
sensing and storing a time when the first user approaches.

5. The method of claim 4, wherein the first user has a radio-frequency identification (RFID) tag and the printing apparatus comprises an RFID reader so that the printing apparatus recognizes that the first user is approaching the printer.

6. The method of claim 1, further comprising calculating a first period from a reception time of the print request signal until a pick up time of the printed document, or a second period from a print completion time until the pick up time of the printed document.

7. The method of claim 6, further comprising updating the pickup information by using a most currently calculated first or second period.

8. The method of claim 7, wherein the pickup information is calculated by: a) averaging at least one previously calculated first period and a currently calculated first period, or b) averaging at least one previously calculated second period and a currently calculated second period.

9. The method of claim 8, wherein a larger weight is applied to a more currently calculated first or second period.

10. The method of claim 1, further comprising receiving the print request signal and the data to be printed from a second user.

11. The method of claim 10, wherein:
the print request signal of the second user comprises a priority print request signal, and
the print order is determined so that the data of the second user is printed sooner than the data of the first user, regardless of the pickup information of the second user.

12. The method of claim 10, wherein:
the print request signal of the second user comprises a priority print request signal, and
wherein the print order is determined by changing of the pickup information of the second user in order to print the data of the second user rapidly.

13. The method of claim 10, further comprising:
recognizing that the second user is approaching the printer, wherein the print order is determined so that the data of the second user is printed sooner than the data of the first user, by recognizing that the second user is approaching the printer.

14. The method of claim 10, further comprising:
recognizing that the second user approaches the printer, wherein the print order is determined by changing the pickup information of the second user in order to print the data of the second user rapidly, by recognizing that the second user is approaching the printer.

15. The method of claim 10, wherein, when the print order is determined in accordance with the pickup information, if the print order of data has already changed a predetermined number of times or more than the predetermined number of times, the print order of the data is determined regardless of the pickup information so that the data is printed with priority.

16. The method of claim 15, wherein, when the print order of the data is determined regardless of the pickup information so that the data is printed with priority, the print order of the data is fixed so as not to be changed or priority is given to the data.

17. A printing apparatus comprising:
a communication unit for receiving a print request signal and data to be printed from a user;
a print order determination unit for determining a print order in accordance with pickup information of the user; and
a printing unit for generating a printed document by printing the data in accordance with the print order.

18. The printing apparatus of claim 17, wherein the print order determination unit comprises a storage determination unit for determining whether the pickup information of the user exists.

19. The printing apparatus of claim 18, wherein the print order determination unit comprises a detection unit for detecting the pickup information of the user if the storage determination unit determines that the pickup information of the user exists.

20. The printing apparatus of claim 17, wherein the print order determination unit comprises a waiting data determination unit for determining whether print waiting data exists.

21. The printing apparatus of claim 17, wherein the print order determination unit comprises a comparison and determination unit for comparing and determining the pickup information of the user and the pickup information corresponding to the print waiting data.

22. The printing apparatus of claim 21, wherein the pickup information comprises a first period from a reception time of the print request signal until a pick up time of the printed document, or a second period from a print completion time until the pick up time of the printed document.

23. The printing apparatus of claim 21, wherein the print order determination unit comprises a control unit for determining the print order so that the smaller the first or second period of a user is, the sooner data of the user is printed, in accordance with a determination result of the comparison and determination unit.

24. The printing apparatus of claim 22, further comprising a pickup information update unit for updating the pickup information by using a most currently calculated first or second period.

25. The printing apparatus of claim 17, further comprising a user recognition unit for recognizing that the user is approaching the printer.

26. The printing apparatus of claim 17, wherein:
the print order determination unit comprises a number determination unit for determining whether the print order is changed a predetermined number of times or more than the predetermined number of times, and
if the print order of data has already changed a predetermined number of times or more than the predetermined number of times, the control unit determines the print order by fixing the print order of the data so as not to be changed or giving priority to the data.
